(19) United States
(12) Patent Application Publication
(10) Pub. No.: US 2026/0268184 A1
(43) Pub. Date: Sep. 10, 2026

(54) Systems and Methods For Leveraging Large Language Model Explainability In Deep Learning Classification

(71) Applicant: Musarubra US LLC, Plano, TX (US)

(72) Inventors: Stefano Bianchi Mazzone, Milano (IT); Chao Sun, Santa Clara, CA (US); Brajesh Kumar, Bangalore (IN); Praveen Soraganvi, Prosper, TX (US)

(21) Appl. No.: 19/405,204

(22) Filed: Dec. 1, 2025

Related U.S. Application Data
(60) Provisional application No. 63/768,718, filed on Mar. 7, 2025.

(51) Int. Cl. G06N 5/045; G06F 16/951; H04L 41/16; H04L 41/22

(52) U.S. Cl. CPC G06N 5/045; G06F 16/951; H04L 41/16; H04L 41/22

(57) ABSTRACT

An explanatory engine is disclosed that explains classifications from a classification system. The explaining engine includes an investigation appliance, an enrichment agent, and an explanatory agent. The investigation appliance is configured to forward a classification result from the classification system to a user and to communicate a user communication related to the classification result. The enrichment agent is configured to generate an enrichment content for the classification result based on the user communication and classification information received from the classification system. The explanatory agent configured to transmit an explanation of the classification result based on the enriched content and the user communication.

### CROSS-REFERENCE TO RELATED APPLICATIONS

This application claims the benefit and priority of U.S. Provisional Patent Application No. 63/768,718, filed Mar. 7, 2025, the entire contents of which are incorporated by reference herein.

### FIELD

Embodiments of the disclosure generally relate to the field of explainable artificial intelligence (XAI) systems. In particular, embodiments of the disclosure relate to explaining classifications using a large language model (LLM).

### GENERAL BACKGROUND

Classification is a process of classifying a prototype or sample into one of several enumerated classes. Classification plays an important role in many applications including security identification, pattern recognition, robotics, computer vision, autonomous vehicles, natural language processing (NLP), and many others. The classification process typically involves predicting a correct label for the sample based on data or features characterizing the sample. Among several methodologies in classification, techniques using artificial intelligence (AI), especially machine learning (ML), has become increasingly popular. Among ML models, deep learning (DL) employs artificial neural networks (ANN) to learn recognition by examples. In this paradigm, a DL system learns to solve a particular problem by using examples with known solutions. An important characteristic of this trend-finding approach is that it does not formulate a well-defined process of classification. Instead, the approach simply looks for trends, or relies on a synthesis of the examples to obtain a classification. The result of this approach is that the solution or the classification is typically described as a black box without any knowledge of the internal structure or the steps that arrive at the solution. While a black-box solution may be acceptable in many applications, it has been increasingly important to look inside the black box to understand how the solution is obtained. The reasons for this need vary according to the industry the DL machines are deployed in but typically include the following: ensuring system trustability for end users, enhancing testing and quality assurance, improving system performance in areas where the deployed DL machines show weaknesses, providing transparency for the decision-making processes, etc.

Explainable AI (XAI) has been developed in the past decades to address this block box issue in DL machines. In essence, XAI aims at explaining the process to reach a decision in DL machines to address the following issues: transparency, trust, accountability, debugging and improvement, and ethics and fairness. Other techniques to go beyond the black-box solutions aim at similar objectives. However, existing techniques have a number of drawbacks. First, the explanations are offered at an abstract level, suitable to specialists or experts, but are not easily comprehensible to laypeople or non-experts. Second, the explanations are often incomplete and sometimes even incorrect because only a set of predefined features is examined without contextual information. Third, there are no opportunities for improving the explanations when new information, including feedback information, is available.

### SUMMARY

Disclosed herein is a computerized method that includes operations of generating a classification result being a classification of an activity object based on one or more predefined criteria, receiving a user input corresponding to a request for a textual explanation of the classification result, generating enrichment content for the classification result based on the user input and classification information received from a classification system, and generating the textual explanation of the classification result through deployment of a generative artificial intelligence (GenAI) model, wherein generating the textual explanation includes providing the classification result and the enrichment content to the GenAI model.

In some embodiments, the operations further comprise generating an alert configured to indicate that the classification result has been generated, and generating a graphical user interface that displays the alert, wherein the graphical user interface is configured to be rendered on a display screen of a network device. In some embodiments, the classification information includes analysis details created by a classification system. In some embodiments, the analysis details include one or more of metadata of a webpage, data obtained from a web crawling, screenshots of the webpage, a source of a HTTP request.

In some embodiments, the activity object is a digital asset including one or more logs generated through computer processing or one or more digital files. In some embodiments, the classification system is a machine learning (ML) model or a deep learning (DL) model. In some embodiments, the operations further comprise initiating a remediation action based on the classification result. In some embodiments, the remediation action is one of attempting to claw back network traffic from the network device, move the network traffic to a designated folder on the network device, or block subsequent network traffic from an internet protocol (IP) address, email address, or domain.

Additional embodiments disclosed herein include a computing device such as a server device or other network device that includes a processor and a non-transitory computer-readable medium having stored thereon instructions that, when executed by the processor, cause the processor to perform operations including: generating a classification result being a classification of an activity object based on one or more predefined criteria, receiving a user input corresponding to a request for a textual explanation of the classification result, generating enrichment content for the classification result based on the user input and classification information received from a classification system, and generating the textual explanation of the classification result through deployment of a generative artificial intelligence (GenAI) model, wherein generating the textual explanation includes providing the classification result and the enrichment content to the GenAI model.

Additional embodiments disclosed herein include a non-transitory computer-readable medium having stored thereon instructions that, when executed by one or more processors, cause the one or more processor to perform operations including generating a classification result being a classification of an activity object based on one or more predefined criteria, receiving a user input corresponding to a request for a textual explanation of the classification result, generating enrichment content for the classification result based on the user input and classification information received from a classification system, and generating the textual explanation of the classification result through deployment of a generative artificial intelligence (GenAI) model, wherein generating the textual explanation includes providing the classification result and the enrichment content to the GenAI model.

These and other features of the concepts provided herein will become more apparent to those of skill in the art in view of the accompanying drawings and following description, which describe particular embodiments of such concepts in greater detail.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is a block diagram illustrating a system in which is an explanatory engine (EE) configured to perform explanations in accordance with some embodiments;

FIG. 2 is a block diagram illustrating an EE shown in FIG. 1 in accordance with some embodiments;

FIG. 3 is a block diagram illustrating an explanation shown in FIG. 2 in accordance with some embodiments;

FIG. 4 is a block diagram illustrating an example of an explanation in accordance with some embodiments;

FIG. 5 is a block diagram illustrating mappings leading to the example of an explanation in FIG. 4 in accordance with some embodiments;

FIG. 6 is a block diagram illustrating the user appliance shown in FIG. 2 in accordance with some embodiments;

FIG. 7 is a block diagram illustrating the enrichment agent shown in FIG. 2 in accordance with some embodiments;

FIG. 8 is a block diagram illustrating the explanatory agent shown in FIG. 2 in accordance with some embodiments;

FIG. 9 is a block diagram illustrating the enhancement agent shown in FIG. 2 in accordance with some embodiments;

FIG. 10 is a flowchart illustrating a process of explaining a classification result in accordance with some embodiments;

FIG. 11 is a flowchart illustrating a process of forwarding the classification result in accordance with some embodiments;

FIG. 12 is a flowchart illustrating a process of generating an enriched content in accordance with some embodiments;

FIG. 13 is a flowchart illustrating a process of transmitting an explanation in accordance with some embodiments;

FIG. 14 is a flowchart illustrating a process of in accordance with some embodiments;

FIG. 15 is a flowchart illustrating a process of transmitting an explanation in accordance with some embodiments;

FIG. 16 is a block diagram illustrating one example flow of network traffic through an enterprise network resulting in analysis by the CSA in accordance with some embodiments;

FIG. 17 is a block diagram illustrating one example flow of a network communication through a networked environment resulting in analysis by the CSA in accordance with some embodiments; and

FIG. 18 is a block diagram illustrating a computing system that implements the intrusion prevention in accordance with some embodiments.

### DETAILED DESCRIPTION

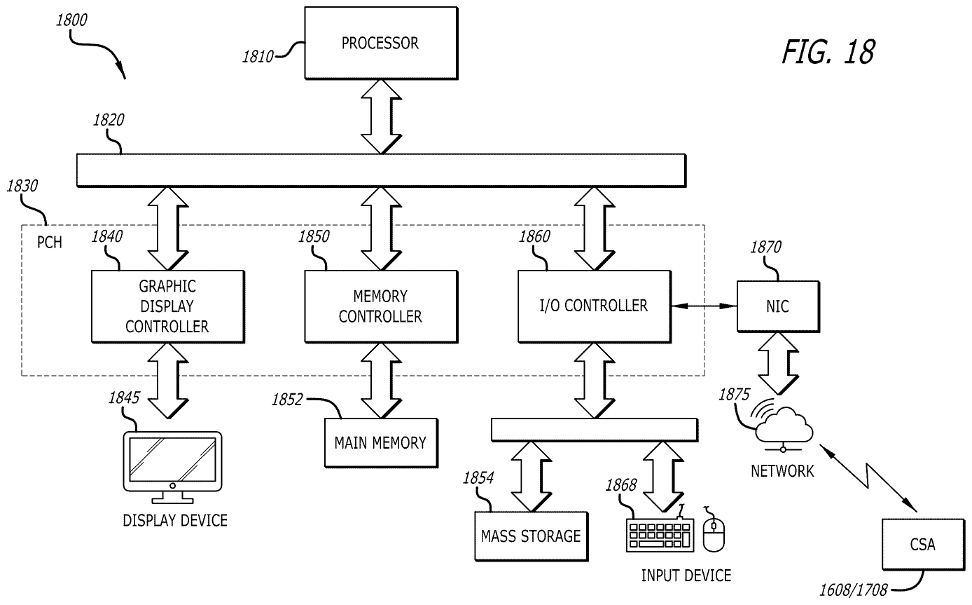

To overcome the disadvantages of existing techniques in explaining the process of arriving at a classification result, an explanatory engine is disclosed that explains classifications from a classification system. The explanatory engine includes an enrichment agent, and an explanatory agent, where the explanatory engine is configured communicatively interact with a user appliance, which may be understood to comprise a network device of the user such as a laptop computer, desktop computer, mobile device, tablet, etc., that is configured with a network interface and certain software applications such as a web browser. In some embodiments, a user appliance may be represented by the computing or processing system 1800 of FIG. 18. The user appliance is configured to render a display including a classification result from the classification system to a user and to communicate a user communication related to the classification result. The enrichment agent is configured to generate an enrichment content for the classification result based on the user communication and classification information received from the classification system. The explanatory agent is configured to transmit an explanation of the classification result based on the enrichment content and the user communication.

One significant component in the explanatory agent is an LLM. The LLM is configured to receive user communications, e.g., prompts, from the user via the user appliance and generate the explanation using the enrichment content and the user communication. The LLM is trained on datasets that are geared toward the activities inspected by the classification system. In addition, the user also interacts with the LLM to guide the LLM toward the components of the explanation via queries or prompts. The prompts focus on items that are important in formulating an explanation. These items include response to questions on the reason, the manner, the time, the place, the things and the subjects that are related to the items or components in the classification. In addition, relationships among the items or components may also be exploited through prompts to the LLM.

### I. Terminology

In the following description, certain terminology is used to describe features of the embodiments. For example, in certain situations, the terms “component” and “logic” are representative of hardware, firmware or software that is configured to perform one or more functions. As hardware, a component (or logic) may include circuitry having data processing or storage functionality. Examples of such circuitry may include, but are not limited or restricted to, a hardware processor (e.g., microprocessor with one or more processor cores, a digital signal processor, a programmable gate array, a microcontroller, an application specific integrated circuit “ASIC”, etc.), a semiconductor memory, or combinatorial elements.

A component (or logic) may be software in the form of a process or one or more software modules, such as executable code in the form of an executable application, an API, a subroutine, a function, a procedure, an applet, a servlet, a routine, source code, object code, a shared library/dynamic load library, or one or more instructions. These software modules may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to, a programmable circuit; semiconductor memory; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage. Upon execution of an instance of a system component or a software module, a “process” performs operations as coded by the software component.

According to one embodiment, the term “malware” may be construed broadly as any code or activity that initiates a malicious attack and/or operations associated with anomalous or unwanted behavior. For instance, malware may correspond to a type of malicious computer code that executes an exploit to take advantage of a vulnerability, for example, to harm or co-opt operation of a network device or misappropriate, modify, or delete data. Malware may also correspond to an exploit, namely information (e.g., executable code, data, command(s), etc.) that attempts to take advantage of a vulnerability in software and/or an action by a person gaining unauthorized access to one or more areas of a network device to cause the network device to experience undesirable or anomalous behaviors. The undesirable or anomalous behaviors may include a communication-based anomaly or an execution-based anomaly, which, for example, could (1) alter the functionality of an network device executing application software in an atypical manner (a file is opened by a first process where the file is configured to be opened by a second process and not the first process); (2) alter the functionality of the network device executing that application software without any malicious intent; and/or (3) provide unwanted functionality which may be generally acceptable in another context. Additionally, malware may be code that initiates unwanted behavior which may be, as one example, uploading a contact list from an endpoint device to cloud storage without receiving permission from the user.

The term “computing device” should be generally construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a computing device may include, but are not limited or restricted to, the following: an endpoint device (e.g., a laptop, a smartphone, a tablet, a desktop computer, a netbook, a medical device, or any general-purpose or special-purpose, user-controlled electronic device configured to support virtualization); a server; a mainframe; a router; or a security appliance that includes any system or subsystem configured to perform functions associated with malware detection and may be communicatively coupled to a network to intercept data routed to or from an endpoint device.

The term “message” generally refers to information transmitted in a prescribed format, where each message may be in the form of one or more packets or frames, a Hypertext Transfer Protocol (HTTP) based transmission, or any other series of bits having the prescribed format. For instance, a message may include an electronic message such as an electronic mail (email) message; a text message in accordance with a SMS-based or non-SMS based format; an instant message in accordance with Session Initiation Protocol (SIP); or a series of bits in accordance with another messaging protocol exchanged between software components or processes associated with these software components.

The term “communication” generally refers to the transmission and/or reception of information. It may also refer to a physical medium that contains information. Examples of communication used in this context include a text, an audio or video file, a recording. A “network communication” refers to the communication that is transmitted or received via a network. It may also refer to a message from a user to the system, such as an inquiry to an LLM or a comment or statement in a conversation with an AI-based system. A “user communication” refers to the communication that is transmitted or received by a user. It may include queries, remarks, comments, or prompts to the LLM.

The term “computerized” generally represents that any corresponding operations are conducted by hardware in combination with software and/or firmware. Also, the term “client” should be interpreted as a software component that is configured to be executed by one or more processors. The client may operate within either of the user or kernel modes of an operating system and may communicate (e.g., exchange data) with software applications or other logic modules. In some instances, a client may correspond to a driver operating in the user mode of the operating system of a computing device.

The term “attack” generally refers to any intentional effort to cause harm or damage to a target by unauthorized access to the target, whether through a network or not. Examples of attack include assets theft, data destruction, behavior altering, infrastructure disabling or interruption. An attack may also include a security or safety violation such as a violent crime, property or identity theft, etc.

The term “intrusion” generally refers to an unauthorized access to a system whether through a network or not. An intrusion by itself is a form of an attack because it invades the boundary of safety and security established by the target of the intrusion and destroys or renders ineffective the established safety and security measures. An intrusion may lead to further harm or damage to the system.

The terms “explanation,” “explain,” “explainable,” and “explanatory” refer to the concept of explainability which, as used herein, expresses the ability to provide clear explanations for AI model predictions, decisions, or classifications. The main objective of explanation is to give insights to the model's behavior in terms of various aspects of the process that leads to the outcome (e.g., predictions, classifications). The insights are expressed in terms that can be easily understood by laypeople without specialized knowledge on the specific subjects related to the model's objectives. Related to the concept of explainability is “interpretability.” In most cases, the two terms may be interchangeable, but there may be some subtle differences. Views on the differences between the two are not unified. In one view, interpretability is related to the inherent model's architecture while explainability is independent of the model itself. In another view, interpretability focuses on how the components of the reasoning process in the model are connected while explainability focuses on why the components used. Such distinctions are not used herein because the “explainability” refers to all aspects of describing and characterizing the outcome of the model (e.g., predictions, classifications) according to the capability of the explanatory agent.

The term “agent” as used herein refers to a functionality that may be implemented by hardware, software, or a combination of hardware and software. It is typically a module that can act independently by interacting with other agents or components in a system. It has a specific task and can perform its task when it receives sufficient inputs or instructions.

The term “engine” as used herein refers to a functionality that may be implemented by hardware, software, or a combination of hardware and software. It is typically a subsystem that can act independently by interacting with other subsystems or components in a system. It has a specific task and can perform its task when it receives sufficient inputs or instructions. It may include agents as its components in carrying out its functions.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

### II. General Network Environment

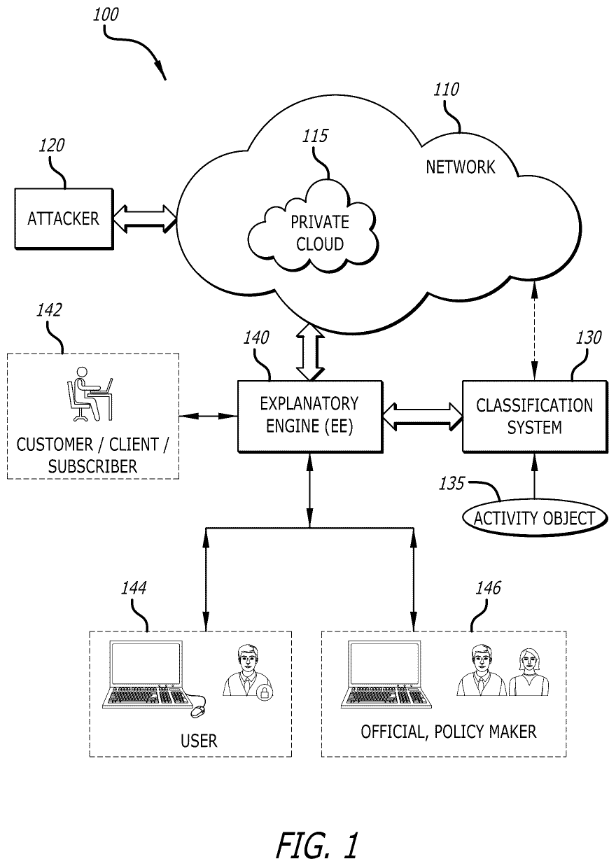

Referring to FIG. 1, a block diagram illustrating system 100 that deploys an explanatory engine configured to perform on premises or with a private cloud in accordance with some embodiments. The system 100 includes a network 110, a cyber attacker 120, a classification system 130, and an explanatory engine (EE) 140. The system 100 may include more or less than the above components. The system 100 as shown in FIG. 1 is an illustrative example of the on-premises or network security environment in which some embodiments may be practiced.

The network 110 is a communication network that connects or links to devices to allow communication among users of the devices. In one embodiment, the network 110 is the Internet. The Internet is a global system of interconnected computer networks. It carries a large range of resources and services such as the interlinked hypertext documents and applications of the World Wide Web (WWW) and electronic mail. The network 110 may also include a wide area network (WAN) or a local area network (LAN). The network 110 provides the users accesses to functions and services via a network communication and a browser. The network communication is a form of communication among users of the network. It includes services or functionalities in a form of an email, a Uniform Resource Locator (URL), a Hypertext Transfer Protocol Secure (HTTPS), a World Wide Web page, and a link. The network 110 may include a private cloud 115. The private cloud 115 is a cloud computing environment where all the computing resources including processing and storage elements are dedicated exclusively to a single organization, such as the enterprise owning the classification system 130 and/or the explanatory engine 140. The private cloud 115 does not share its resources with other users and may be hosted on the enterprise's data center or a third-party provider.

The attacker 120 is an individual, an organization, a robot, or an artificial intelligence (AI)-designed function that intentionally causes harms or damages to a user of a networked system by malicious acts such as stealing, exposing, altering, disabling, or destroying data, applications or other assets through unauthorized access to a network, computer system or digital device. Tactics use by the attacker 120 are varied and may include any one of network attacks including virus (e.g., Trojan Horse virus), Domain Name Service (DNS) tunneling, malware attacks, ransomware attacks, social engineering scams, business email compromise (BEC) scams, and data and password thefts. One popular type of cyberattack is the transmission of malicious URLs within network communications. Attacks geared towards LLMs include mainly jailbreaks, prompt injection, and data poisoning. In addition, attacks may be in other forms such as ethical boundary violations and data privacy breaches.

The classification system 130 is a system designed to classify an activity object 135 into one or more classes according to some predefined objectives or criteria. The objectives or criteria may be any objectives that an enterprise, an organization, or an individual wants to achieve and that are related to the explanatory engine 140. Examples of these objectives include network security, attack detection and prevention, intrusion prevention, deepfake detection, cloud email security, threat detection, market research, medical diagnosis, product reviews, or any other objectives that involve classifications. In one embodiment, the classification system 130 is one of a non-learning model, a machine learning (ML) model, and a deep learning (DL) model, or a combination of these models. The non-learning model are typically based on predefined or heuristic rules or logic. It typically makes classification decisions based on explicit criteria established by the model designer. Examples of this type of model include rule-based systems, expert systems, and classifiers that classify based on some predefined criteria without any learning process. Since the rules are clearly defined, this type of model is easy to understand and often does not need explanations. The ML or DL model aims at AI-based classifications using a learning process. This type of model operates on a set of training data and includes an iterative process that generates the classification based on a self-organizing structure. Because the self-organizing structure is opaque, it is difficult to understand the learning process. The classification result therefore needs an explanation. The classification system 130 generate classification results upon receiving the activity object 135. It is configured to detect a suspicious activity related to security.

The activity object 135 includes any object that may trigger a concern related to the objectives or criteria. It may be a physical item such as a text, a message, an image, a screenshot, an audio clip, a video clip. It may also be an action or a series of acts such as a transmission of a series of requests.

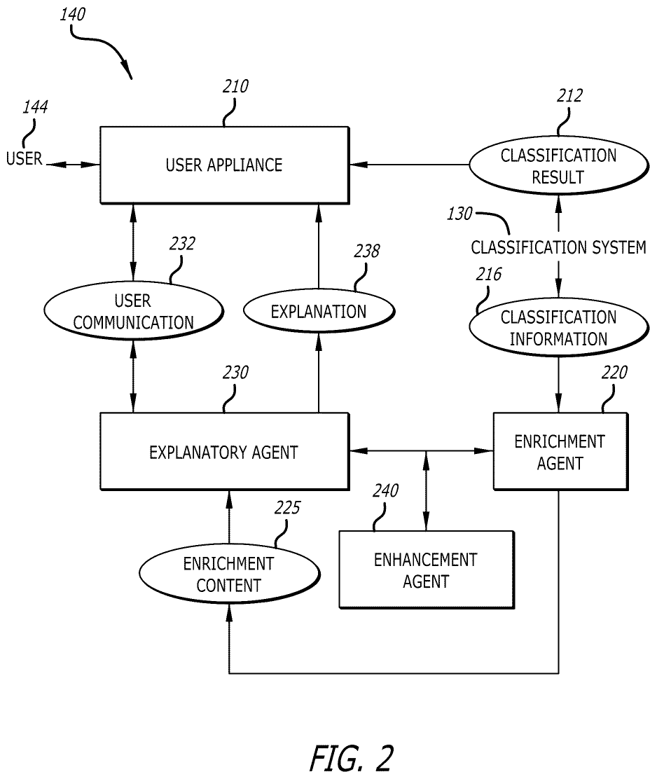

The explanatory engine 140 is an AI-based asset that generate explanations of the classification results generated by the classification system 130. The explanatory engine 140 interacts with a customer, client, or subscriber (customer) 142, a user 144, or an official or policy maker 146 to provide explanations, conduct conversations, acquire feedback information, and receive guidelines to refine or update its performance. The explanations may be any suitable format such as human-like texts or in a form that can be understood by the customer 142, the user 144, or the official or policy maker 146. The explanatory engine 140 will be described further with more details in FIG. 2.

The customer 142 may be an individual, an entity, or an organization that interacts with the system including the explanatory engine 140 and optionally the classification system 130. The customer 142 typically has no knowledge or control over the explanatory engine 140 and merely uses the explanatory engine 140 and the classification system 130 as part of the efforts to achieve the objectives. For example, if the objective is security, the customer 142 may install the explanatory engine 140 and the classification system 130 in their computers to process the activity object 135 and scan for any security issues.

The user 144 may be an individual or an AI-based agent that mimics human behavior, or a combination of a human operator and an AI-based agent. The user 144 interacts with the explanatory engine 140 by issuing user communications to help developing the explanatory engine 140 in its process in providing an explanation for the classification results from the classification system 130. The user 144 may receive the initial classification result, formulate a prompt or a query or a set of prompts or queries to seek an explanation for the classification result or steer the explanation in a proper direction, communicate with the explanatory engine 140 to transmit the query or the set of queries, receive responses from the explanatory engine 140, and provide feedback to the explanatory engine 140. In one embodiment, the user 144 is a human operator such as an analyst from a security operations center (SOC). The SOC analyst is typically a security professional who is well versed in cyber threats or security issues and familiar with the requirements or criteria of the enterprise or business organization that deploys the explanatory engine 140 in their security system. In one embodiment, the user 144 may conduct a conversation with the explanatory engine 140 in a chatbot or chatbot-like environment to receive responses, provide feedback and prompts to guide or update the explanatory engine 140 in generating the explanation. In another embodiment, the user 144 may be an AI-agent trained to auto-generate prompts or queries based on the classification result or subsequent responses from the explanatory engine 140. The user 144 may be an LLM trained with datasets focused on query generation in the specialized subject domain that the explanatory engine 140 and the classification system 130 are deployed. In yet another embodiment, the user 144 may be a combination of a human operator and an AI-based agent working together to interact with the explanatory engine 140 to help updating or improving the explanatory engine 140 in its task of generating explanations for the classification results.

As will be described later, the explanatory engine 140 employs an LLM as the core component for generating explanations. Within this framework, the user 144 is a part of a feedback loop that integrates human or human-like agent to guide, refine, and improve the LLM. The process is iterative to ensure that LLM aligns more closely with human values, preferences, and real-world applications. The interaction between the LLM and the user 144 is leveraged to implement this sort of feedback loop and achieve incremental refining of the overall experience.

The official 146 may represent the authority in establishing the requirements, criteria, or guidelines in issues regarding the underlying objectives. For example, if the objective is network security, the requirements may include guidelines with emphasis on URL scanning and virus prevention. The official 146 may also participate in the development or training the explanatory engine 140 to help the explanatory engine 140 performs its task consistent with the requirements or criteria of the business organization. The official 146 may represent an official or an employee of the enterprise or the organization using the explanatory engine 140. He or she may be responsible for the administration of the safety and security of the organization. He or she may be responsible for the installation, configuration, maintenance, and updating of the explanatory engine 140. It should be noted that while a singular noun is used, the designation may also refer to plural. In other words, the official 146 may refer to an individual or a group of individuals.

### III. Representation of an Explanatory Engine

Referring to FIG. 2, a block diagram illustrating the explanatory engine 140 in FIG. 1 is shown in accordance with some embodiments. The explanatory engine 140 includes a user appliance 210, an enrichment agent 220, an explanatory agent 230 and an enhancement agent 240. The explanatory engine 140 may include more or less than the above components.

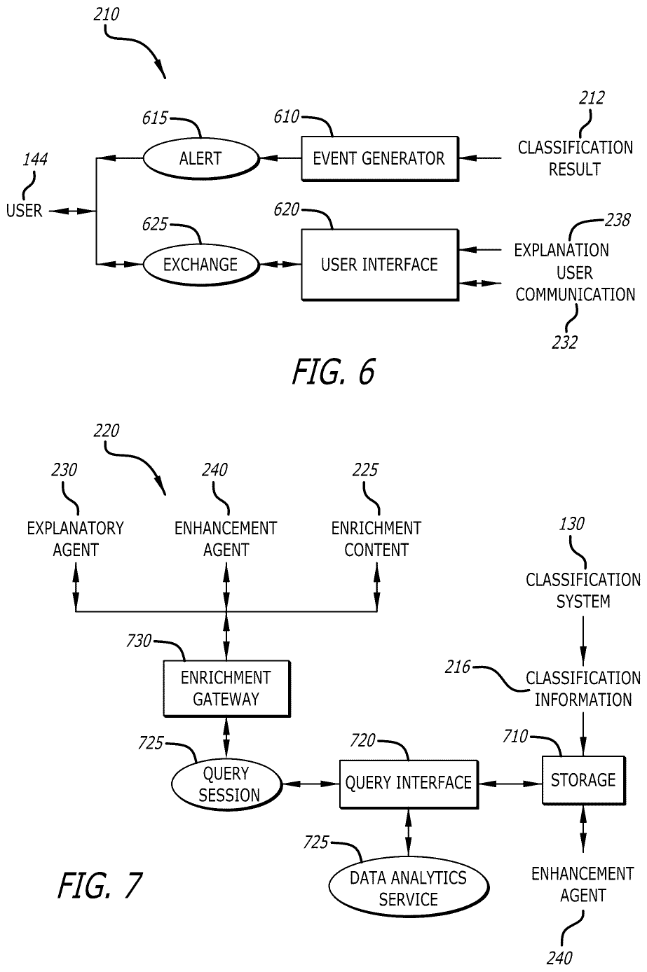

The user appliance 210 is configured to forward a classification result 212 from the classification system 130 to the user 144 and to communicate a user communication 232 related to the classification result 212. The user communication 232 may include feedback, queries, or conversational items from the user 144. The user communication 232 may include prompts that help guide the output of the explanatory agent 230. The user appliance 210 will be described further in FIG. 6.

The enrichment agent 220 is configured to generate an enrichment content 225 for the classification result 212 based on the user communication 232 and classification information 216 received from the classification system 130. The classification information 216 may include information from the analysis details provided by the classification system 130. This information may include metadata of an URL, a screenshot of a webpage, or other contextual information. The enrichment agent 220 will be described further in FIG. 7. The enrichment content 225 may include information that may format or interpret the classification information, represent the user feedback including queries and prompts and validation. The enrichment agent 220 interacts with the explanatory agent 230 and the enhancement agent 240 to exchange information.

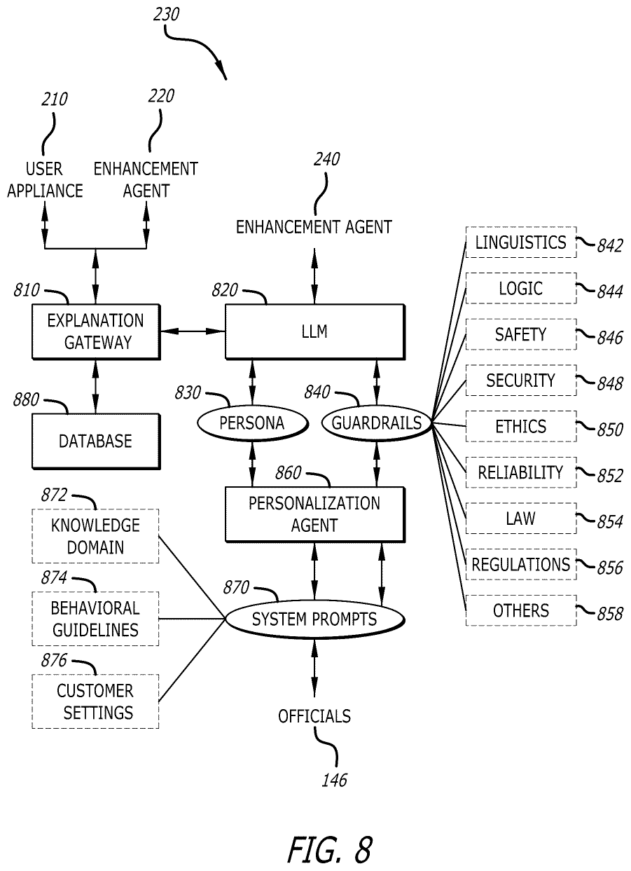

The explanatory agent 230 is configured to transmit an explanation 238 of the classification result 212 based on the enrichment content 225 and the user communication 232. The explanatory agent 230 formulates the explanation 238 by extracting relevant information from the enrichment content 225 which includes the classification information 216 and the user communication 232 which includes the user feedback and queries. As will be described in FIG. 8, the core component in the explanatory agent 230 is an LLM which is trained to provide meaningful substances for the explanation 238. Employing an LLM to provide explanations for an ML model or even another LLM used in the classification system 130 represents a novel idea in the embodiments. The explanatory agent 230 will be described further in FIG. 8.

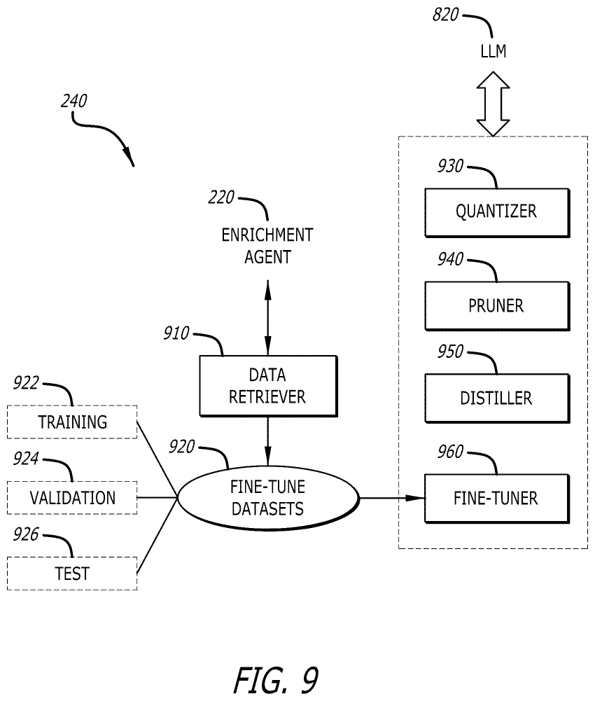

The enhancement agent 240 is configured to enhance the LLM in the explanatory agent 230 based on the user communication and performance criteria and to fine-tune the LLM based on evaluation data. The enhancement may include making the LLM more efficient, faster, and smaller. The enhancement agent 240 will be described further in FIG. 9.

Finding an explanation for a result obtained by an unknown process involves an investigation of items related to the process. The investigation is in essence an exploration process that attempts to extract information that may not exist initially but may become apparent when the investigation goes deeper and deeper. In the context of LLMs, this exploration may be efficiently performed by techniques in prompt engineering. Prompt engineering refers to techniques that force the LLMs to focus attention on items raised in prompts. A prompt is a query, a comment, a statement that triggers a specific response from an LLM. It in essence guides the LLM in the direction that the user wants to LLM to go. In finding an explanation, a prompt engineering task often follows a well-crafted approach. In one embodiment, this approach involves the use of responses to questions and the establishments of relationships. From a system point of view, relationships among elements in the system play an important role in explaining the system because they reveal how each element interacts with others which ultimately lead to the overall system's behavior. Aiding to establishing relationships, soliciting information is facilitated by posing questions on the reason, the manner, the time, the place, the things and the subjects that are related to the items or components in the system.

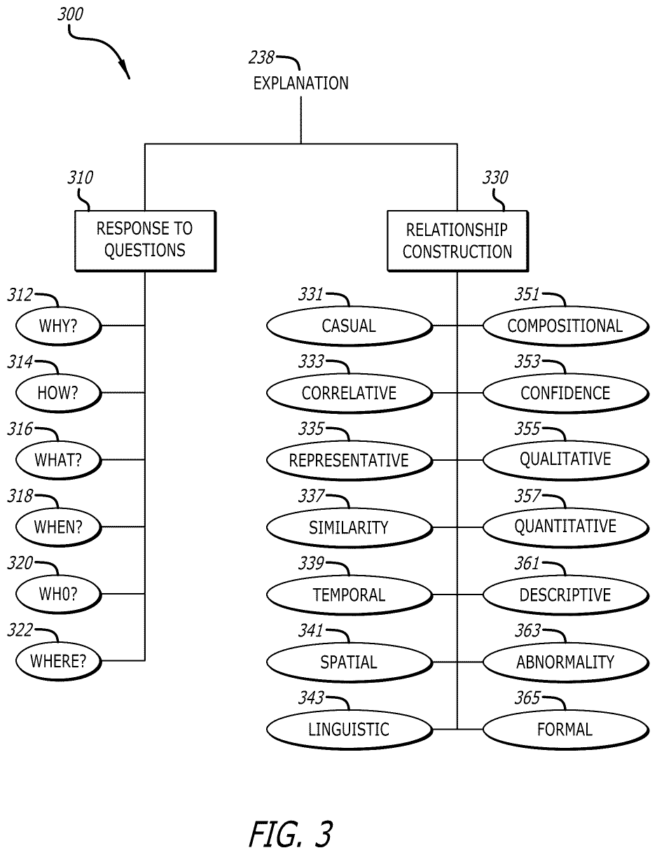

FIG. 3 is a block diagram illustrating an example of the approach 300 to formulate the explanation 238 shown in FIG. 2 in accordance with some embodiments. The approach 500 used by the explanatory agent 230 to formulate the explanation 238 include a set 310 of responses to questions and a relationship construction 330. The approach 300 may include more or less than the above components.

The set 310 includes responses, answers or replies to the questions related to the description or characterization of the classification result 212. By forming explanations based on these questions, the explanatory agent 230 can obtain insights that may not be available in the classification result 212. These questions include a why question 312, a how question 314, a what question 316, a when question 318, a who question 320, and a where question 322. These questions are related respectively to the reason, the manner, the things, the time, the subjects, and the place involving the items in the classification. The why question 312 inquires about the reason or cause behind an action, a result, a consequence, or an effect. It forces the responder to focus on the causal connections between the items. The how question 314 inquires about the manner, method, or process of an action or a formation of a result. Other questions inquire about various aspects of an item or a process. These questions help gathering specific information related to the classification result. They may be used in conjunction with open questions to narrow down the scope of explanation. The following is an example to illustrate the use of the responses 310 in formulating an explanation.
Reply: “The request has a subdomain POxEckRzBA.”
Question: “What is a subdomain?”
Reply: “A subdomain is a prefix added to a domain name to create a separate section of a website.”

The responses 310 include replies to the why question 312, the how question 314, the what question 316, the when question 318, the who question 320, and the where question 322. These replies may be used to provide context to the classification result 212 and can help in formulating the explanation 238. In the above example, the what question 316 helps leading to the terms “prefix,” “domain name,” “section,” and “website” which may be further inquired to obtain more relevant information.

The relationship construction 330 constructs relationships between items in the responses or results. By exploiting the relationships, the explanatory agent 230 may be able to piece the connections of various aspects of the classification result 212 into a coherent and comprehensive text for the explanation 238. There are many types of relationship that can be constructed. The following list is only an example. The list includes a causal relationship 331, a correlative relationship 333, a representative relationship 335, a similarity relationship 337, a temporal relationship 339, a spatial relationship 341, a linguistic relationship 343, a compositional relationship 351, a confidence relationship 353, a qualitative relationship 355, a quantitative relationship 357, a descriptive relationship 361, an abnormality relationship 363, and a formal relationship 365. The types of these relationships are as named. For example, the causal relationship 331 establishes the cause and effect between two items.

The set 310 of responses and the relationship construction 320 may be used as basis for generating prompts to the LLM in the explanatory agent 230. The prompts may be generated during a conversation between the user 144 and the explanatory agent 230. These prompts include queries, remarks, or comments that may trigger a response from the LLM. The following exemplary conversation illustrates this process.
User 144: “What is the decision of the classification system?”
Explanatory Agent 230: “The classification system decides that the activity in question is DNS tunneling.”
User 144: “How many classifiers used in the classification system?”
Explanatory Agent 230: “Five classifiers are used.”
User 144: “Are these five classifiers have similar confidence levels?”
Explanatory Agent 230: “Looks like so. Their probabilities are 0.97, 0.98, 0.97. 0.99, and 0.99.”
User 144: “Are there uppercase and lowercase characters and numbers in the subdomains?”
Explanatory Agent 230: “Now that you mention it, I realize that they do have a mix of lowercase and uppercase characters, letters, and numbers.”

As seen from the above example, the user 144 poses questions in a form of prompts that help the LLM to focus attention to areas the user 144 wants it to focus. The prompts exploit the responses to questions and the relationships to provide bases for explanations.

To illustrate the formation of the explanation 238, an example on DNS tunneling will be given. In this example, several activity objects 135 are given to the classification system 130 which returns a classification result 212. The classification result 212 declares that the activity objects 135 correspond to a DNS tunneling attack. The classification result 212 is submitted to the explanatory engine 140 for analysis. After the analysis, the explanatory agent 230 generates the final explanation 238 which includes six sub-explanations that correspond to six features of the activity objects 135.

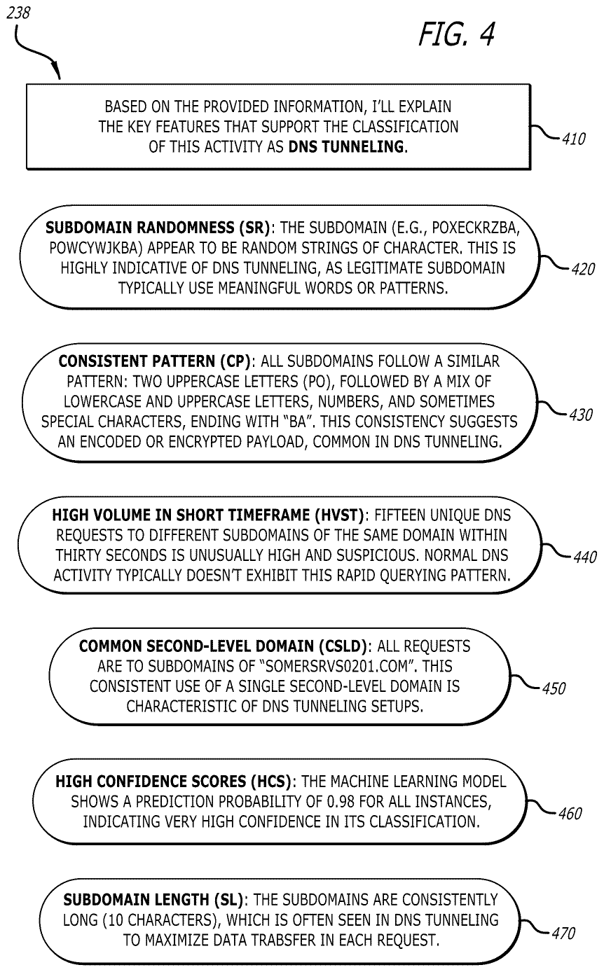

FIG. 4 is a block diagram illustrating an example of the explanation 238 for the DNS tunneling example in accordance with some embodiments. The explanation 238 includes a statement 410, a subdomain randomness (SR) sub-explanation 420, a consistent pattern (CP) sub-explanation 430, a high volume in short timeframe (HVST) sub-explanation 440, a common second-level domain (CSLD) 450, a high confidence score (HCS) 460, and a subdomain length (SL) 470.

FIG. 4 shows the texts that describe the above sub-explanations. These explanations explain the classification results based on the above six instances of the activity objects 135. These activity objects 135 are different and independent. They all reflect a consistency of the occurrences of the patterns in the instances. The explanatory agent 230 formulates the explanation 238 based on at least one of the user communication 232, the classification 216, and the enrichment content 225. This formulation may be achieved by the feedback from the user 144 in a form of queries or prompts, the rich content and other information. As an illustration, the formulation may be viewed under the approach 300 shown in FIG. 3.

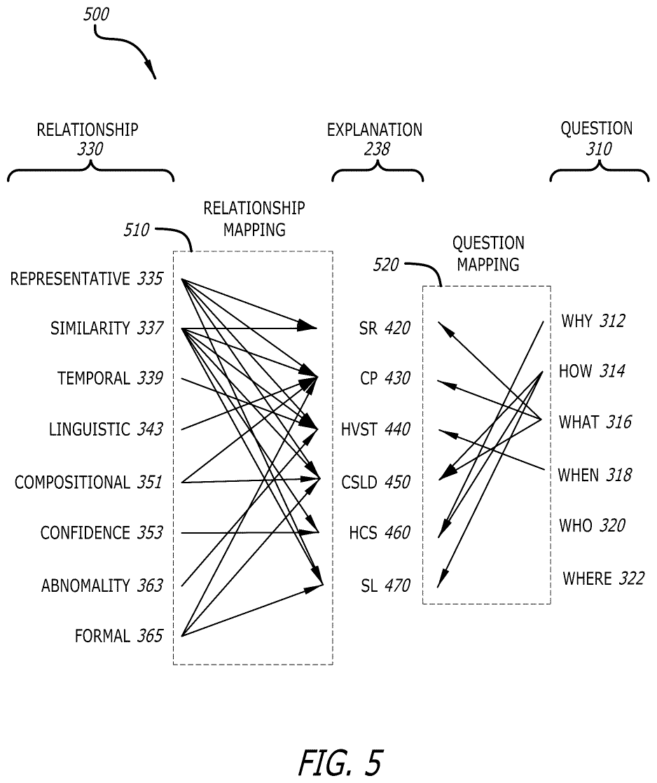

FIG. 5 is a block diagram illustrating a mapping 500 leading to the example of an explanation in FIG. 4 in accordance with some embodiments. The mapping 500 includes a relationship mapping 510 and a question mapping 520. The mapping 500 may include more or less than the above mappings.

The relationship mapping 510 shows how different types of relationship leads to the sub-explanation. By looking for relationships among the items in the classification result 212 or classification information 216, the explanatory agent 230 is able to pull out the corresponding sub-explanations. It should be noted not all relationships shown in FIG. 3 contribute to the sub-explanations shown in FIG. 4. For example, the representative relationship 335 leads to five sub-explanations because these five instances are representative of a DNS tunneling activity. The representative relationship 335 does not lead to the HCS 460 because high confidence scores may not be representative of DNS tunneling. They may be representative of any other activities detected by all the models. The similarity relationship 337 leads to all six instances because the similar appearances of these activities are consistent with the DNS tunneling. The temporal relationship 339 is only established in the HVST 440. The linguistic relationship 3434 is established only in the CP 430. The compositional relationship 351 exists in CP 430 because the letters and numbers are parts of the subdomains, and CSLD 450 because the single second-level domain is part of a domain. The confidence relationship 353 exists only in HCS 460 because all instances have very high prediction probabilities. The abnormality relationship 363 exists in HVST 440 because the activity is known as an abnormal activity. The formal relationship 365 is established in CP 430 and SL 470 because in these sub-explanations, the items are characterized according to their form.

The question mapping 520 shows the links between the questions and the sub-explanations. By forcing the questions, the explanatory agent 230 is able to obtain the sub-explanations that correspond to the question. The why question 312 triggers the HCS 460. The how question 314 leads to the CSLD 450, the HCS 460, and the SL 470. Other mappings are as shown in FIG. 5

Both the relationship mapping 510 and the question mapping 520 are combined and they reinforce each other to allow the explanatory agent 230 to formulate meaningful statements for the explanation 238. Additional information is also used to further reinforce the explanation 238 such as the enrichment content 225 and the inherent structure of the explanatory agent 230. The explanatory agent 230 will be described in more details in FIG. 8.

FIG. 6 is a block diagram illustrating the user appliance 210 shown in FIG. 2 in accordance with some embodiments. The user appliance 210 includes an event generator 610 and a user interface 620. The user appliance 210 may include more or less than the above components.

The event generator 610 is configured to generate an alert 615 to the user 144 about the classification result 212. The alert 615 helps the user 144 to start the session of generating the explanation. This may include downloading appropriate datasets, initializing parameters or initial weights, configuring the LLM or selecting the LLM based on the persona and the guardrails, etc.

The user interface 620 is configured to communicate with the user 144 and to formulate the user communication 232 based on the classification result 212 forwarded from the event generator 620 and an exchange 625 with the user 144. The formulation of the user communication 232 may include arranging the queries, preparing the queries on questions and relationships, formatting the query or the statement in a proper form. The exchange 625 refers to the conversation between the user 144 and the explanatory agent 230.

FIG. 7 is a block diagram illustrating the enrichment agent 220 shown in FIG. 2 in accordance with some embodiments. The enrichment agent 220 includes a storage 710, a query interface 720, and an enrichment gateway 730. The enrichment agent 220 may include more or less than the above components.

The storage 710 is configured to store the classification information 216 from the classification system 130 and the user communication 232 from the user appliance 210 via the enrichment gateway 730. The classification information 216 and the user communication 232 may be used as training data for current session or future sessions.

The query interface 720 is configured to analyze the classification information 216 using a data analytics service 725. The data analytics service may be a third-party service or developed in house. The data analytics service helps analyze the data based on the queries from the query interface 720. In essence, data analytics involve collecting, organizing, and analyzing the data to identity patterns, trends, and correlations to extract meaningful insights on the data.

The enrichment gateway 730 is configured to communicate with the explanatory agent 230 to transmit the enrichment content 225 and to generate a query session 725 with the query interface 720. The enrichment content 225 include all relevant information collected in the query interface 720 and the storage 710.

FIG. 8 is a block diagram illustrating the explanatory agent 230 shown in FIG. 2 in accordance with some embodiments. The explanatory agent 230 includes an explanation gateway 810, an LLM 820, a personalization agent 860, and a database 880. The explanatory agent 230 may include more or less than the above components.

The explanation gateway 810 is configured to communicate with the enrichment agent 220 and the user appliance 210 via the user communication 232. The explanation gateway 810 channels the information to the LLM 820 including queries or prompts from the user 144 and the datasets to be used by the LLM 820. It also passes data or information to the database 880. It also transmits the explanation 238 from the LLM 820 to the user appliance 210.

The LLM 820 is configured to interact with the explanation gateway 810 to generate the explanation 238 using the enrichment content 225 and the user communication 232 and to receive queries or prompts from the user 144 via the user communication 232. In general, the LLM 820 employs deep learning techniques in language comprehension, text interpretation, and text generation and composition. The LLM 820 typically has access to a variety of information or databases including public, private, and proprietary databases. The LLM 820 is trained to provide explanations on the classification result 212. The training data comes from a variety of sources including internal datasets, the enrichment content 225, and the user communication 232. In addition, the LLM 820 may also access public information via the network 110 to obtain contextual information related to the classification. The information is auto-inspected to ensure it follows the guardrails discussed below. The LLM 820 interacts with the enhancement agent 240 to further improve its performance such as reducing its size or being fine-tuned to focus on specific areas.

The personalization agent 860 is configured to provide a persona 830 and guardrails 840 for the LLM 820 based on system prompts 870 on at least one of a knowledge domain 872, behavioral guidelines 874, and customer settings 876. The LLM 820 is selected according to the persona 830 and guardrails 840. The persona 830 refers to the trait or behavior of the LLM 820. The guardrails 840 are a set of rules or practices that control the outputs of the LLM 820 to ensure they are legal, safe, ethical, and reliable. The guardrails 840 can help prevent harmful or biased content, such as misinformation, offensive language, or privacy violations. In one embodiment, the guardrails 840 include safeguards on linguistics 842, logic 844, safety 846, security 848, ethics 850, reliability 852, law 854, regulations 856, and others 858. The guardrails 840 may be imposed as part of the training data to the LLM 820 or as the quality assurance step before finalizing the explanation 238. For example, the linguistics guardrail 842 ensures that the explanation conforms with proper grammar and syntax; the logic guardrail 844 checks the explanation 238 to make sure that the reasoning is sound and no logical or formal fallacies are committed; the safety guardrail 846 ensures that the explanation 238 is free of violence or crime; the security guardrail 848 make sure that the explanation does not reveal any secret or confidential information; the ethics guardrail 850 ensures that no ethical violation is committed such as privacy violation; the reliability guardrail 852 ensures that the explanation is highly reliable such as the classification result achieves a high score of confidence; the law guardrail 854 checks if the explanation violates any federal, state, or local laws; the regulations guardrail 856 ensures that the explanation follow the guidelines by federal, state, or local regulations; and the others guardrail 858 refers to any other guardrails that may be relevant.

The database 880 stores data or information via the explanation gateway 810. The data or information may include the user communication 232, the explanation 238, the enrichment content 225, the classification information 216, and any other pertinent information collected in previous and current sessions.

FIG. 9 is a block diagram illustrating the enhancement agent 240 shown in FIG. 2 in accordance with some embodiments. The enhancement agent 240 includes a data retriever 910, a quantizer 930, a pruner 940, a distiller 950, and a fine-tuner 960. The enhancement agent 240 may include more or less than the above components.

The data retriever 910 may retrieve the user communication 232 from the storage 710 in the enrichment agent 220 to form fine-tune datasets 920. The fine-tune datasets 920 use a text-based format such as the JavaScript Object Notation (JSON) or JSON Lines (JSONL) format. It may include three different types of datasets: a training dataset 922, a validation dataset 924, and a test dataset 926.

The quantizer 930, the pruner 940, the distiller 950, and the fine-tuner 960 may operate independently, in parallel or serial manner. They all interact with the LLM 820. They may function periodically, or at times after the user 144 is communicating with the explanatory engine 140. Since the user communication 232 and the enrichment content 225 often contain useful data including feedback acting as validation data, they may provide new training data for these components.

The quantizer 930 may reduce precision of weights used in the LLM 820. The arithmetic calculations in the LLM 820 may use a high-precision word length, e.g., 32-bit. The quantizer 930 may reduce this precision to 16-bit or even 8-bit. A lower precision makes the model lighter, faster, and more energy efficient without significantly affecting its performance.

The pruner 940 may remove at least a non-significant part of the LLM 820. The pruner 940 focuses on parts that are considered less or non-significant relative to other parts. This may include eliminating neurons or layers that contribute minimally to the model's output. Pruning reduces the model's size and complexity. To prune effectively, the pruning may take place in conjunction with the training so that the effect of pruning can be observed.

The distiller 950 may distill knowledge from a large model and to transfer the distilled knowledge to the LLM 820. The large model is typically a previous version of the LLM 820. The knowledge in an LLM is basically the neurons, the layers, and other parameters, distilling knowledge is a process of selecting the neurons, the layers, and other parameters that perform essentially with similar result as the larger LLM. In one embodiment, this may be done by first creating a new version of the LLM 820. This new version is similar to the existing version with much less memory. Then, the new version is trained with the dataset created by the existing version. In other words, the dataset is the same as the dataset operated on by the existing version without the labels. The labels are then supplied by the outputs of the existing version.

The fine-tuner 960 may fine-tune the LLM 820 by adjusting the weights on a task-specific dataset based on the fine-tune datasets as above. The training dataset 922 is used to train the LLM 820. It is the largest dataset among the three and it allows the LLM 820 to adjust its weights or other parameters. The validation dataset 920 is used to validate the result of the LLM 820 during training. The test dataset 926 is used to test the LLM 820 with unseen data. The datasets are geared toward the objective of the system, or more particularly, the classification system 130. For example, if the classification system 130 is designed to detect malicious URL, then the datasets will include a large collection of labeled URLs, including both benign and malicious URLs with classifications. The features of the datasets for malicious URL detection may include features of a URL, such as domain names, path components, query parameters, and website content. Since the LLM 820 is designed to explain the classifications, not to perform the classification, the datasets will include the explanations for the classifications. The datasets may be pre-stored in the storage 710 or may be updated through past sessions with user communication 232 including feedback from the user 144.

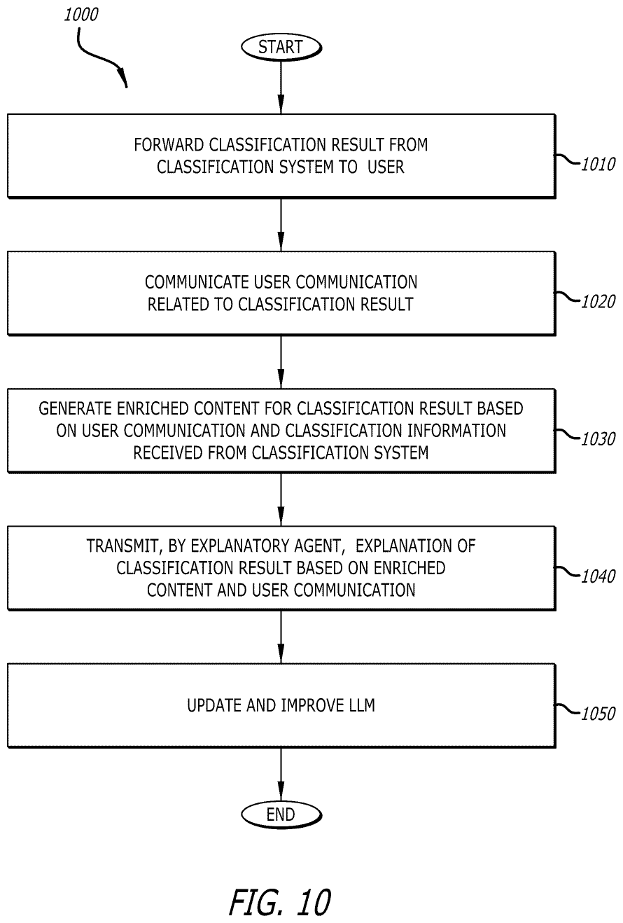

FIG. 10 is a flowchart illustrating a process 1000 of explaining a classification result in accordance with some embodiments. The process 1000 may follow the structure of the explanatory engine 140 shown in FIG. 2.

Upon START, the process 1000 forwards a classification result from a classification system to a user (Block 1010). The classification result is typically the final decision or prediction of the classification system about an activity object that may trigger a security event such as a URL, a request for data, a request for domain, etc. The classification result may include the class the activity object belongs to, such as benign, malicious, safe, unsafe, etc. Then, the process 1000 communicates a user communication related to the classification result (Block 1020). The user communication may be a query, a prompt that is designed to gear the explanatory agent in some direction, a confirmation of a result, a piece of conversation like in chat with a chatbot, etc. Next, the process 1000 generates an enrichment content for the classification result based on the user communication and classification information received from the classification system (Block 1030). The enrichment content may include contextual information related to the classification result. This may be obtained or filtered from the classification system itself. This may also be obtained from previous sessions with other classifications, or from public or private databases with contents similar to the type of activities the classification system is dealing with.

Then, the process 1000 transmits, by an explanatory agent, an explanation of the classification result based on the enriched content and the user communication (Block 1040). The explanation is the output of an LLM that is trained by the user communication and the enrichment content and guided by a set of guardrails designed specifically for the activity. Next, the process 1000 updates and improves the LLM (Block 1050). The update or improvement may make the LLM be more efficient, less memory requirements, and faster. The process 1000 is then terminated.

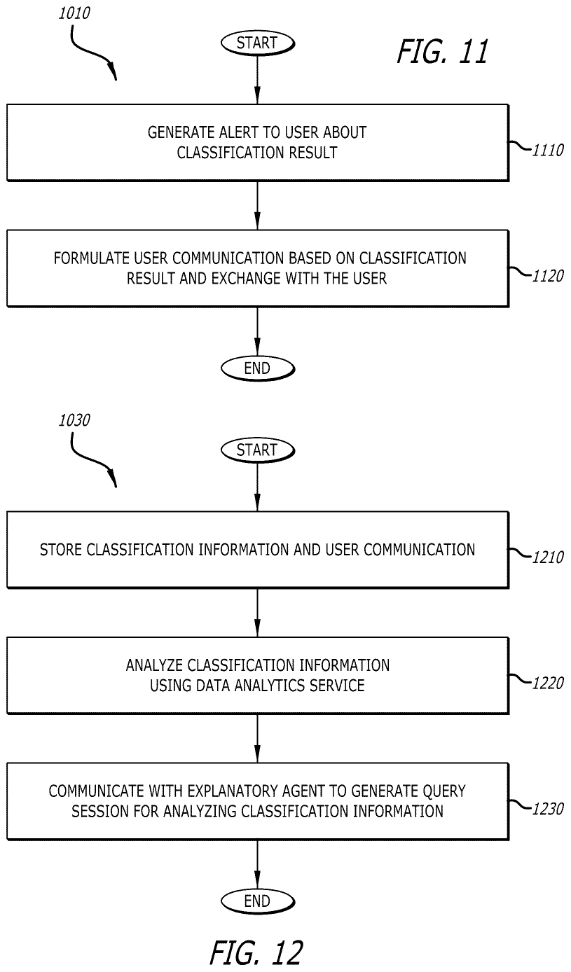

FIG. 11 is a flowchart illustrating the process 1010 of forwarding the classification result in accordance with some embodiments.

Upon START, the process 1010 generates an alert to the user about the classification result (Block 1110). The alert may serve as a signal to initialize the system, activate databases, establish connections, and populate components with appropriate parameters or data. Next, the process 1010 formulates the user communication based on the classification result and an exchange with the user (Block 1120). The formulation may include arranging of queries, identifying the potential relationships, or formatting a query in proper form for inquiries. The process 1010 is then terminated.

FIG. 12 is a flowchart illustrating the process 1030 of generating an enrichment content in accordance with some embodiments.

Upon START, the process 1030 stores the classification information and the user communication (Block 1210). The classification information may include the analysis details created by the classification system such as metadata of a website, data obtained from a web crawling, screenshots of a webpage, sources of the requests, etc. Next, the process 1030 analyzes the classification information using a data analytics service (Block 1220). The data analytics service may be a third-party service or developed in house. The data analytics service helps analyze the data based on the queries. Then, the process 1030 communicates with the explanatory agent to transmit the enrichment content and to generate a query session for analyzing the classification information (Block 1230). The process 1030 is then terminated.

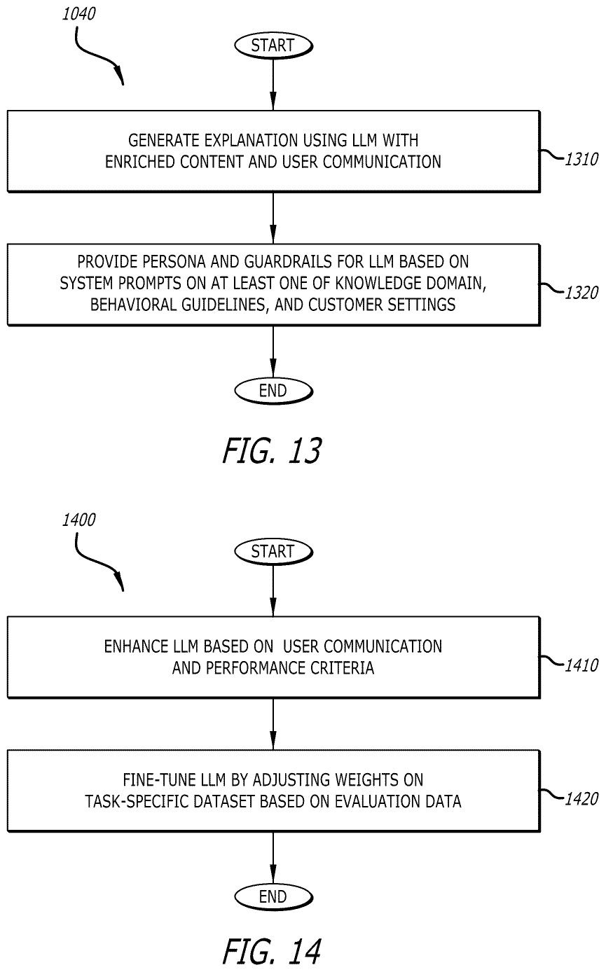

FIG. 13 is a flowchart illustrating the process 1040 of transmitting an explanation in accordance with some embodiments.

Upon START, the process 1040 generates the explanation using an LLM with the enrichment content and the user communication (Block 1310). The enrichment content and the user communication provide additional data or information that is useful to establishing relationships or responses to inquiries. Next, the process 1040 provides a persona and guardrails for the LLM based on system prompts on at least one of a knowledge domain, behavioral guidelines, and customer settings (Block 1320). The system prompts are typically generated by an authority of the overall system. The persona and the guardrails characterize the LLM. There may be several LLMs with different personas and/or guardrails. The LLM is selected according to the persona and guardrails. The guardrails may include a set of rules to formulate the explanation according to criteria related to at least one of linguistics, logic, safety, security, ethics, reliability, law, and regulations. The process 1040 is then terminated.

FIG. 14 is a flowchart illustrating a process 1400 of enhancing the LLM in accordance with some embodiments.

Upon START, the process 1400 enhances the LLM based on the user communication and performance criteria (Block 1410). Next, the process 1400 fine-tunes the LLM by adjusting the weights on a task-specific dataset based on evaluation data (e.g., fine-tune datasets) (Block 1420). The fine-tune data sets are described above. The process 1400 is then terminated.

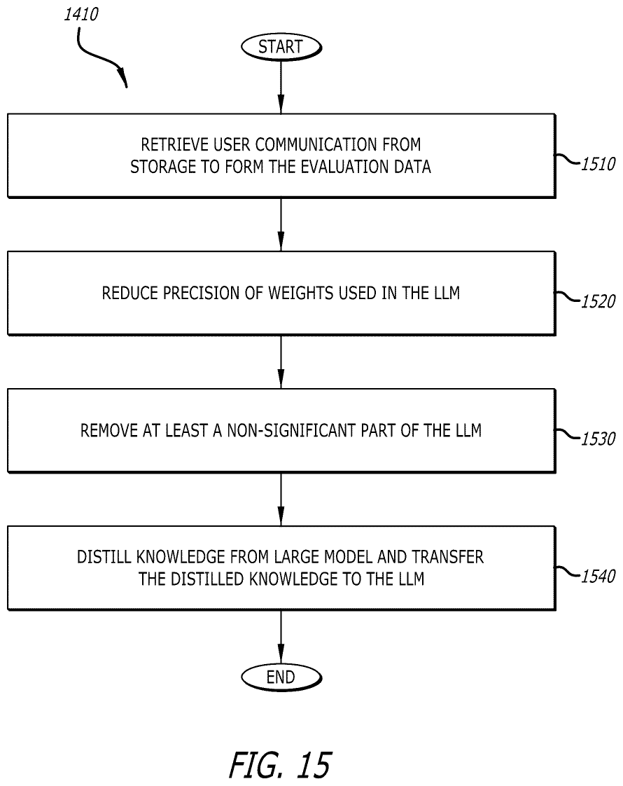

FIG. 15 is a flowchart illustrating the process 1410 of enhancing the LLM in accordance with some embodiments.

Upon START, the process 1410 retrieves the user communication from a storage to form the fine-tune datasets (Block 1510). The fine-tune datasets include a training dataset, a validation dataset, and a test dataset. The datasets may be created by attaching explanations to a classification. Next, the process 1410 reduces precision of weights used in the LLM (Block 1520). This may involve reducing the word length, say from 32-bit to 16-bit or 8-bit. Then, the process 1410 removes at least a non-significant part of the LLM (Block 1530). The non-significant part may be a layer, a node or a neuron, a parameter, or a set of weights that do not contribute significantly to the outcome of the LLM. Next, the process 1410 distills knowledge from a large model and transfers the distilled knowledge to the LLM (Block 1540). This may be done by creating a new version of the LLM and train this new version with the existing version. The new version is smaller such as a smaller number of layers. The process 1410 is then terminated.

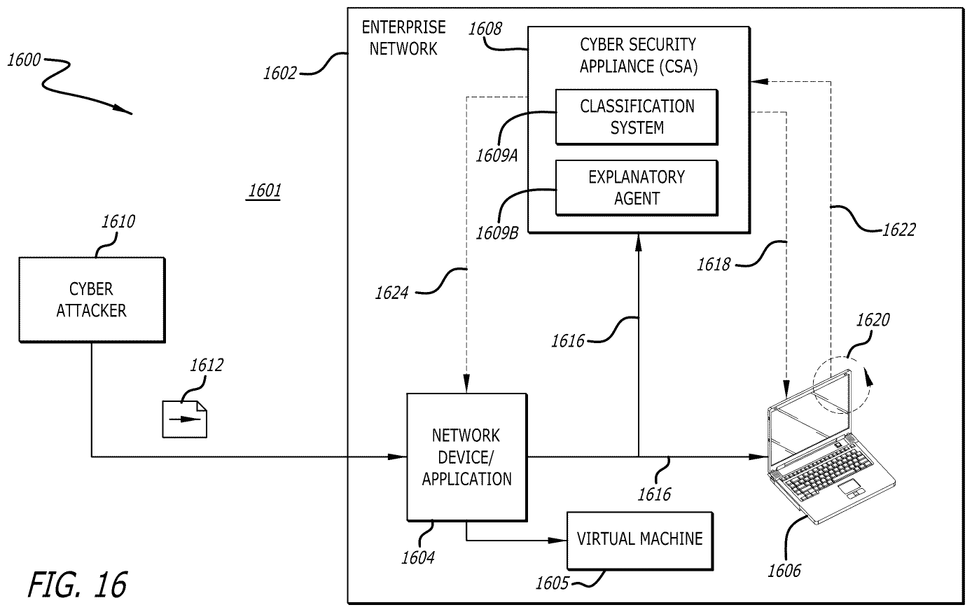

FIG. 16 is a block diagram illustrating one example flow of network traffic through an enterprise network resulting in analysis by the CSA 1708 in accordance with some embodiments. The networked environment 1600 includes numerous components that are communicatively coupled through one or more networks such as a network 1601, which may be a public or private network, as well as the enterprise network 1602. As shown, some components such as a network device of a cyber attacker 1610, may operate on the network 1601 and outside of the enterprise network 1602 while other components may operate on the enterprise network 1602 behind a network appliance 1604 (e.g., a firewall). For example, a network device 1606 of a user and a cyber security appliance (CSA) 1608 may sit behind the firewall 1604.

The firewall 1604 may be configured to receive network traffic entering and exiting the enterprise network 1602, such as network traffic 1612. FIG. 16 illustrates that the network device 1606 may be connected to the enterprise network 1602, and thus, the receive network traffic 1612 after it passes through the firewall 1604. The CSA 1608 may also be positioned behind the firewall 1604 and receive a copy of the network traffic 1612 (e.g., copy 1616 that passed initial screening or filtering of the firewall 1604) as such is being transmitted to the network device 1606. It should be understood that the CSA 1608 and the firewall 1604 may also analyze aspects of outbound network traffic (not shown), which may include network traffic from the network device 1606 to the network device of the cyber attacker 1610. Analysis of outbound network traffic may be to review for exfiltration and/or communications with a command-and-control (C2) server.

The CSA 1608 is shown to include a classification system 1609A and an explanatory agent 1609B. The classification system 1609A may be configured to perform one or more malware analyses that result in a classification of the network traffic 1612 as being benign, suspicious, malicious, etc., and in some instances, provide classifications such as phishing, virus, worm, trojan, ransomware, spyware, adware, rootkit, botnet, malware (generally), etc. In instances in which the CSA 1608 determines the network traffic 1612 is benign or otherwise does not classify the network traffic 1612 as anomalous, suspicious, or malicious (e.g., being or containing malware), the CSA 1608 need not take any remediation action.

However, when the CSA 1608 classifies the network traffic 1608 as anomalous, suspicious, or malicious, the CSA 1608 may alert such to the network device 1606 via communication 1618, e.g., such that an alert, notification, or other indicator is visually displayed or audibly relayed to a user. Additionally, in some examples, the CSA 1608 may take one or more remediation actions such as attempting to claw back the network traffic or move the network traffic to a designated folder (e.g., when the network traffic is a network communication such as an email), delete or otherwise quarantine the network traffic (e.g., when the network traffic is a document or file), block additional communications to/from the cyber attack 1610 (e.g., block an email address, email address from a particular domain), block additional network traffic to/from a particular IP address, etc. The remediation action(s) are illustrated in FIG. 16 through the operation icon 1620. Following one or more remediation actions, the CSA 1608 may receive a notification of such actions via communication 1622. The CSA 1608 may also provide remediation instructions 1624 to the firewall 1604, such as to block an IP address corresponding to the source of the copy 1616, discard or delete current network traffic packets received from the I P address corresponding to the source of the copy 1616, transmit future network traffic received from the I P address corresponding to the source of the copy 1616 to a virtual machine 1605 for processing thereof before sending to the network device 1606, etc.

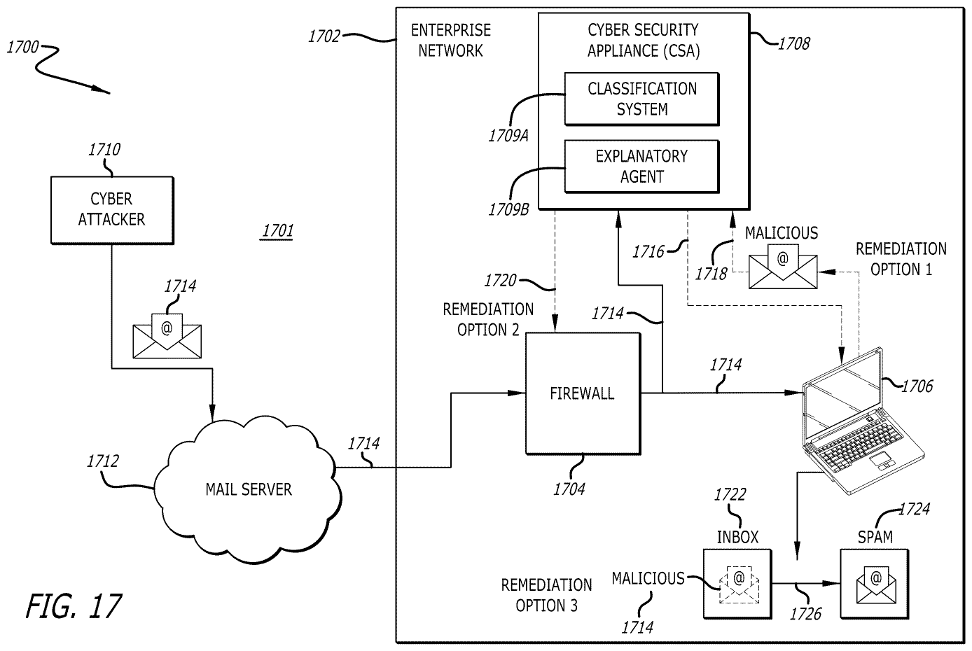

FIG. 17 is a block diagram illustrating one example flow of a network communication through a networked environment resulting in analysis by the CSA 1708 in accordance with some embodiments. The networked environment 1700 includes numerous components that are communicatively coupled through one or more networks such as a network 1701, which may be a public or private network, as well as the enterprise network 1702. As shown, some components such as a network device of a cyber attacker 1710 and a mail server 1712, may operate on the network 1701 and outside of the enterprise network 1702 while other components may operate on the enterprise network 1702 behind a network appliance 1704 (e.g., a firewall). For example, a network device 1706 of a user and a cyber security appliance (CSA) 1708 may sit behind the firewall 1704.

The mail server 1712 may represent a cloud-based mail server for example. The firewall 1704 may be configured to receive network communications entering and exiting the enterprise network 1702, such as a network communication 1714. FIG. 17 illustrates that the network device 1706 may be connected to the enterprise network 1702, and thus, the receive network communication 1714 after it passes through the firewall 1704. The CSA 1708 may also be positioned behind the firewall 1704 and receive a copy of the network communication 1714 as such is being transmitted to the network device 1706. The CSA 1708 is shown to include a classification system 1709A and an explanatory agent 1709B. The classification system 1709A may be configured to perform one or more malware analyses that result in a classification of network traffic (e.g., the network communication 1714) as being benign, suspicious, malicious, etc., and in some instances, provide classifications such as phishing, virus, worm, trojan, ransomware, spyware, adware, rootkit, botnet, malware (generally), etc. In instances in which the CSA 1708 determines the network communication 1714 is benign or otherwise does not classify the network communication 1714 as anomalous, suspicious, or malicious (e.g., being or containing malware), the CSA 1708 need not take any remediation action.

However, when the CSA 1708 classifies the network communication 1714 as anomalous, suspicious, or malicious, the CSA 1708 may alert such to the network device 1706 via communication 1716, e.g., such that an alert, notification, or other indicator is visually displayed or audibly relayed to a user. Additionally, in some examples, the CSA 1708 may take one or more remediation actions such as a first action of automatically attempting to claw back the anomalous, suspicious, or malicious network communication, which is illustrated as claw back operation 1718 (e.g., performed through one or more API calls). A second action may be to automatically engage and communicate with the firewall 1704 to block further network communications (or generally network traffic) from the sender or domain (or even the IP address of the sender), where sender refers to the cyber attacker 1710 (“remediation operation 2,” which is illustrated as communication 1720). In some examples, the CSA 1708 may cause subsequent network traffic or network communications received from the sender (email address, domain, IP address) to be dropped, e.g., blocked and not provided to a recipient network device positioned within the enterprise network 1702 and behind the firewall 1704. A third action may be to perform an operation to automatically move the network communication 1714 (now understood as the malicious network communication), following analysis by the CSA 1708, from a first location to a second location within the user's mail client application, e.g., from an inbox 1722 to a spam folder 1724 (or blocked folder, trash bin, etc.), which is illustrated by the operation 1726.

FIG. 18 is a diagram illustrating a computing or processing system 1800 that implements the explanatory engine 140 according to an embodiment. The computing system 1800 may be a host in a system on which the explanatory engine 140 operates. In one embodiment, the computing system 1800 performs the operations described in FIG. 2. It includes a central processing unit (CPU) or a processor 1810, a platform controller hub (PCH) 1830, and a bus 1820. The PCH 1830 may include a graphic display controller (GDC) 1840, a memory controller 1850, and an input/output (I/O) controller 1860. The processing system 1800 may include more or less than the above components. In addition, a component may be integrated into another component. As shown in FIG. 18, all the controllers 1840, 1850, and 1860 are integrated in the PCH 1830. The integration may be partial and/or overlapped. For example, the GDC 1840 may be integrated into the processor 1810, the I/O controller 1860 and the memory controller 1850 may be integrated into one single controller, etc.

The processor 1810 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 1810 may have simultaneous multithreading feature to further exploit the parallelism due to multiple threads across the multiple cores. In addition, the processor 1810 may have internal caches at multiple levels. The bus 1820 may be any suitable bus connecting the processor 1810 to other devices, including the PCH 1830. For example, the bus 1820 may be a Direct Media Interface (DMI). The PCH 1830 in a highly integrated chipset that includes many functionalities to provide interface to several devices such as memory devices, input/output devices, storage devices, network devices, etc.

The I/O controller 1860 controls input devices 1868 (e.g., stylus, keyboard, and mouse, microphone, image sensor) and output devices (e.g., audio devices, speaker, scanner, printer), and a mass storage 1854. The mass storage 1854 may also include CD-ROM, hard disk, and SSDs. It also has a network interface card (NIC) 1870 which provides interface to a network such as the network 110 in FIG. 1 and wireless medium 1475.

The memory controller 1850 controls memory devices such as a main memory 1852. The main memory 1852 includes random access memory (RAM) and/or the read-only memory (ROM) and other types of memory such as the cache memory or a solid-state drive (SSD). The main memory 1852 may store instructions or programs, loaded from a mass storage device, that, when executed by the processor 1810, cause the processor 1810 to perform operations as described above. It may also store data used in the operations. The ROM may include instructions, programs, constants, or data that are maintained whether it is powered or not. The instructions or programs may correspond to the functionalities described above.

The GDC 1840 controls a display device 1845 and provides graphical operations. It may be integrated inside the processor 1810. It typically has a graphical user interface (GUI) to allow interactions with a user who may send a command or activate a function. Additional devices or bus interfaces may be available for interconnections and/or expansion. The bus interfaces may be serial or parallel, with or without power delivery, etc.

As discussed above, embodiments of the disclosed explanatory engine offer several technical advantages that are superior to existing approaches in explainable AI. The following are representative advantages:
Transparency: The explanatory engine 140 provides high quality explanations for events that may be difficult to evaluate. The high quality is achieved by using the LLM 820 trained with specialized data to generate the explanations. The training data include the user communication which may act as queries or prompts to steer the LLM in a proper direction. The queries or prompts may include questions regarding why, how, when, what, who, and where and relationships among elements in the classification information.
Efficiency: Leveraging condensed data in LLMs can significantly speed up retrieval of contextual information related to the underlying activities. The LLM 820 has its own persona and guardrails specifically developed for the tasks at hand. This structure avoids unnecessary examination or consideration of unrelated or irrelevant information.
Scalability: The explanatory engine 140 includes components that are easily expanded, updated, or improved. There are no limits on the number of alerts, user communications, or explanations. Accordingly, the explanatory engine 140 may be scaled to accommodate a variety of problems with different requirements.
User friendliness: The LLM 820 and the user communication 232 are characterized by human-like texts. The training data include feedback from the user 144 with realistic and specific information. The LLM 820 is prompted with familiar terms including responses to the questions and establishment of relationships that are commonly known.
High quality explanations: The overall system employs several innovative ideas including an LLM trained for explanations, a feedback loop involving a human or human like operator, a rich content that includes classification information from the classification system and other contextual information, the prompts that guide the LLM incorporate elements that exploit explanation include responses to questions and relationships. The result is that the explanations provided by the LLM are easy to understand, realistic, and highly reliable.

In the foregoing description, the disclosure is described with reference to specific exemplary embodiments thereof. It will, however, be evident that various modifications and changes may be made thereto without departing from the broader spirit and scope of the disclosure as set forth in the appended claims.

What is claimed is:

1. A computerized method:
generating a classification result being a classification of an activity object based on one or more predefined criteria;
receiving a user input corresponding to a request for a textual explanation of the classification result;
generating enrichment content for the classification result based on the user input and classification information received from a classification system; and
generating the textual explanation of the classification result through deployment of a generative artificial intelligence (GenAI) model, wherein generating the textual explanation includes providing the classification result and the enrichment content to the GenAI model.

2. The computerized method of claim 1, further comprising:
generating an alert configured to indicate that the classification result has been generated; and
generating a graphical user interface that displays the alert, wherein the graphical user interface is configured to be rendered on a display screen of a network device.

3. The computerized method of claim 1, wherein the classification information includes analysis details created by a classification system.

4. The computerized method of claim 3, wherein the analysis details include one or more of metadata of a webpage, data obtained from a web crawling, screenshots of the webpage, a source of a HTTP request.

5. The computerized method of claim 1, wherein the activity object is a digital asset including one or more logs generated through computer processing or one or more digital files.

6. The computerized method of claim 1, wherein the classification system is a machine learning (ML) model or a deep learning (DL) model.

7. The computerized method of claim 1, further comprising:
initiating a remediation action based on the classification result.

8. The computerized method of claim 1, wherein the remediation action is one of attempting to claw back network traffic from the network device, move the network traffic to a designated folder on the network device, or block subsequent network traffic from an internet protocol (IP) address, email address, or domain.

9. A computing device comprising:
a processor; and
a non-transitory computer-readable medium having stored thereon instructions that, when executed by the processor, cause the processor to perform operations including:
generating a classification result being a classification of an activity object based on one or more predefined criteria,
receiving a user input corresponding to a request for a textual explanation of the classification result,
generating enrichment content for the classification result based on the user input and classification information received from a classification system, and
generating the textual explanation of the classification result through deployment of a generative artificial intelligence (GenAI) model, wherein generating the textual explanation includes providing the classification result and the enrichment content to the GenAI model.

10. The computing device of claim 9, wherein the operations further comprise:
generating an alert configured to indicate that the classification result has been generated; and
generating a graphical user interface that displays the alert, wherein the graphical user interface is configured to be rendered on a display screen of a network device.

11. The computing device of claim 9, wherein the classification information includes analysis details created by a classification system.

12. The computing device of claim 11, wherein the analysis details include one or more of metadata of a webpage, data obtained from a web crawling, screenshots of the webpage, a source of a HTTP request.

13. The computing device of claim 9, wherein the activity object is a digital asset including one or more logs generated through computer processing or one or more digital files.

14. The computing device of claim 9, wherein the classification system is a machine learning (ML) model or a deep learning (DL) model.

15. The computing device of claim 9, wherein the operations further comprise:
initiating a remediation action based on the classification result.

16. The computing device of claim 9, wherein the remediation action is one of attempting to claw back network traffic from the network device, move the network traffic to a designated folder on the network device, or block subsequent network traffic from an internet protocol (IP) address, email address, or domain.

17. A non-transitory computer-readable medium having stored thereon instructions that, when executed by one or more processors, cause the one or more processor to perform operations including:
generating a classification result being a classification of an activity object based on one or more predefined criteria;
receiving a user input corresponding to a request for a textual explanation of the classification result;
generating enrichment content for the classification result based on the user input and classification information received from a classification system; and
generating the textual explanation of the classification result through deployment of a generative artificial intelligence (GenAI) model, wherein generating the textual explanation includes providing the classification result and the enrichment content to the GenAI model.

18. The non-transitory computer-readable medium of claim 17, wherein the operations further comprise:
generating an alert configured to indicate that the classification result has been generated; and
generating a graphical user interface that displays the alert, wherein the graphical user interface is configured to be rendered on a display screen of a network device.

19. The non-transitory computer-readable medium of claim 17, wherein the classification information includes analysis details created by a classification system, wherein the analysis details include one or more of metadata of a webpage, data obtained from a web crawling, screenshots of the webpage, a source of a HTTP request.

20. The non-transitory computer-readable medium of claim 17, wherein the activity object is a digital asset including one or more logs generated through computer processing or one or more digital files, and wherein the classification system is a machine learning (ML) model or a deep learning (DL) model.

21. The non-transitory computer-readable medium of claim 17, wherein the operations further comprise:
initiating a remediation action based on the classification result, wherein the remediation action is one of attempting to claw back network traffic from the network device, move the network traffic to a designated folder on the network device, or block subsequent network traffic from an internet protocol (IP) address, email address, or domain.
